(19) United States
(12) Patent Application Publication
(10) Pub. No.: US 2021/0027317 A1
(43) Pub. Date: Jan. 28, 2021

(54) INVENTORY AND STRUCTURE FINDER

(71) Applicant: Capital One Services, LLC, McLean, VA (US)

(72) Inventors: Saman BAGHESTANI, McLean, VA (US); Prasad PATHAPATI, McLean, VA (US)

(73) Assignee: Capital One Services, LLC, McLean, VA (US)

(21) Appl. No.: 16/523,728

(22) Filed: Jul. 26, 2019

(51) Int. Cl. G06Q 30/02; G06Q 30/06; G06Q 40/02; G06Q 20/40

(52) U.S. Cl. CPC G06Q 30/0201; G06Q 30/0609; G06Q 20/403; G06Q 40/025; G06Q 30/0627

(57) ABSTRACT

Disclosed herein are system, method, and computer program product embodiments for providing a search result to a seller using a sales management tool that narrows an inventory to items that simultaneously meet consumer-affordability and lender-policy requirements. By considering numerous permutations of available financial structures associated with the inventory and a potential customer's financial constraints, a seller may recommend items that a customer is already pre-approved for. This removes guesswork and human error from the process of determining affordability while meeting lender-set policies. One embodiment describes providing search results tailored to a particular customer based on lender-policy requirements within a vehicle dealership researching vehicles to recommend to a potential customer. By limiting the full gamut of available financial structures for the inventory of vehicles to those that satisfy a potential customer's financial constraints from the very inception of the search process, the sales management tool eliminates guesswork and human error from vehicle recommendation.

### BACKGROUND

Businesses use sales management tools to manage inventories, track sales, handle finances, market goods and services, create invoices, and perform a wide-array of other tasks. For instance, car dealerships traditionally harness a sales management tool to catalog available vehicles and store associated data including: make, model, color, price, number of days in the inventory, etc. A sales representative may access a sales management tool to determine suitable items to recommend to a potential customer. The sales management tool may also generate invoices, record sales, update the inventory, and otherwise facilitate relationships and interactions with customers.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of an environment including a sales management tool, according to some embodiments.

FIG. 2 is an example screen display of a search result in a sales management tool, according to some embodiments.

FIG. 3 is an example screen display of a search-result details page in a sales management tool, according to some embodiments.

FIG. 4 is a flowchart illustrating a method of providing a search result to a seller using a sales management tool, according to some embodiments.

FIG. 5 is a flowchart illustrating a method of building a dealer profile in a sales management tool, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a search result in a sales management tool that limits an inventory to a subset that simultaneously satisfies consumer-affordability and lender-policy requirements.

Sales management tools provide businesses, for example vehicle dealerships, capabilities to track inventory, complete sales transactions, create invoices, receive payment, record customer behaviors and preferences, etc. To track inventory, a sales management tool may store additional detailed information about items in the inventory. In a vehicle dealership example, which will be referred to throughout this disclosure, such information may characterize the vehicles owned by a particular dealership (e.g., stored/available on the dealership's premises) and may include vehicle identification numbers, pricing information, ownership history, vehicle characteristics such as make, model, year, and color, and other vehicle-related data. As the dealership acquires additional vehicles and sells vehicles, the sales management tool may update the inventory to reflect the changes. The following paragraphs will continue to describe the interactions between a sales representative and the sales management tool with respect to the vehicle-dealership example, but one skilled in the relevant art(s) will appreciate that the described interactions apply equally to other sales paradigms, i.e., any situation with a stored inventory of items being offered for sale by a seller.

When a potential customer arrives at a dealership (either in person, virtually, or otherwise), a sales manager, sales representative, employee, or other suitable individual may access the sales management tool to determine an appropriate vehicle to offer to the potential customer. To identify the appropriate vehicle, the sales representative may form a basic and general understanding of the customer's financial constraints and personal goals. For example, in the interest of formulating a tailored recommendation for the potential customer, a sales manager may inquire about financial details such as the potential customer's credit score, desired monthly payment, desired down payment, monthly income, personal debt, etc. The sales manager may also ask the potential customer about brand preferences, desired vehicle colors, stylistic concerns, and other consumer preferences. Finally, the sales manager may consider the policies and characteristics of their dealership, for example, a focus at the dealership on maximizing profits or a push to sell vehicles that have remained on the lot for the lengthiest amount of time.

With the potential customer's financial constraints and preferences in mind, a sales representative may next take stock of the available vehicles at the dealership and then hazard a mere guess as to which vehicle to recommend to the potential customer. Subsequently, the sales representative may conduct further research into the vehicle's qualities, provide detailed information about the vehicle to the customer, allow the potential customer to test drive the vehicle, and engage in other sales tactics, approaches, and methods. If the potential customer likes the vehicle, the potential customer may then negotiate a price or other financial considerations with the dealer.

Customarily, if the customer decides that they would like to purchase the vehicle, the sales manager then may verify that a lender even offers financing structures to finance the purchase transaction. The sales manager may then locate and gather more details about these financing structures. These financing structures may include factors such as an amount of down payment, an APR or interest rate, a monthly payment, a term length, and various other suitable financing conditions.

However, in some instances, financing structures may not be available, i.e., a qualified lender may not offer a structure that matches the consumer constraints and the desired vehicle. For example, the price of the vehicle may exceed a potential customer's affordability range. In other scenarios, the financial structures may not be acceptable to the dealer for a variety of reasons, in which case negotiations may need to be recommenced and the deal may fall through. Similarly, the down payment or other financing structure may be unacceptable to the potential customer, and the potential customer may decide to walk away from the deal. In all of these scenarios, the dealership, sales representative, and potential customer wasted effort considering a particular vehicle from the outset. The purchase/sale was doomed from its inception given that the financing structures for the vehicle, consumer constraints, and lender-approval were unacceptable and/or unavailable.

Accordingly, a need exists to consider permutations of available financial structures alongside the inventory of vehicles in a manner that satisfies a potential customer's financial constraints from the inception of an inventory search process. In this fashion, a sales representative may view items, e.g., vehicles, in search results that are limited to the items that satisfy the customer's financial constraints and lender policy requirements, removing guesswork and human error from the process.

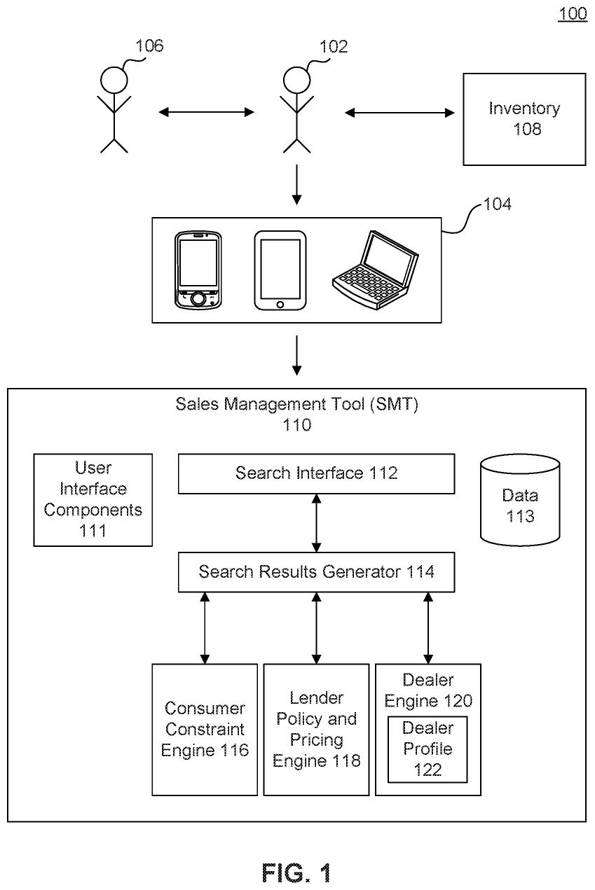

FIG. 1 is a block diagram of an environment including a sales management tool, according to some embodiments. Environment 100 may include user 102, computing device 104, potential customer 106, inventory 108, and sales management tool 110.

User 102 may be a sales agent, employee, or other representative of a business or organization. In one embodiment, user 102 may be a salesperson or employee at a vehicle dealership. In another embodiment, user 102 may be a sales representative from any appropriate business or company having an inventory of other suitable items, e.g., a clothing retailer, a wine store, a grocery store, etc. User 102 may be an individual (i.e., a human being) or group of such individuals. In yet another embodiment, user 102 may be an artificial intelligence construct. In some embodiments, user 102 may be a potential customer of a business interacting with sales management tool 110 to determine a desired item without the assistance of a sales representative. In an embodiment, user 102 may access sales management tool 110 by accessing a stored user account, e.g., using a username/password combination.

Computing device 104 may be a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof. Therefore, it will also be appreciated that any two or more components of environment 100 may similarly be executed using some or all of the two or more computers in communication with one another. In an embodiment, computing device 104 may connect to sales management tool 110 via any network or combination of networks including the Internet, a local area network (LAN), a wide area network (WAN), a wireless network, a cellular network, or various other types of networks as would be appreciated by a person of ordinary skill in the art. In another embodiment, computing device 104 may have software installed thereon that facilitates the behaviors and functions of sales management tool 110.

Potential customer 106 may be an individual, group, or other construct seeking to purchase an item within an inventory. In one embodiment, potential customer 106 may be a consumer visiting, either in person, virtually, or through any other means, a dealership to investigate the purchase of an automobile, truck, motorcycle, bicycle, or other vehicle. Potential customer 106 may provide consumer constraints, i.e., budget-related factors, such a credit score, a credit history, a monthly income, debt obligations, etc. In an embodiment, potential customer 106 may be tracked in sales management tool 110 with an appropriate user account associated with potential customer 106. In an embodiment, potential customer 106 may interact with systems that are ancillary to sales management tool 110, for example, personal banking systems. In this embodiment, sales management tool 110 may have access to details about the consumer constraints of potential customer 106 by accessing the ancillary systems via an API call or other suitable interaction mechanism.

Inventory 108 may be an inventory of tangible or intangible items available at a business or other commercial entity. In one embodiment, the items in inventory 108 are vehicles and the business offering the vehicles for sale is a car dealership. In this embodiment, inventory 108 may be the available vehicles that potential customer 106 may be presented. In other embodiments, inventory 108 may be an inventory of food, electronics, clothes, or any other consumer product. Inventory 108 may be digital objects, such as media files, streams, or software. In some embodiments, the items in the inventory are not sold at all, rather rented, leased, or otherwise transferred from the seller to the buyer. One skilled in the relevant art(s) will appreciate that the variety of items that may kept in inventory 108 is expansive and far-reaching.

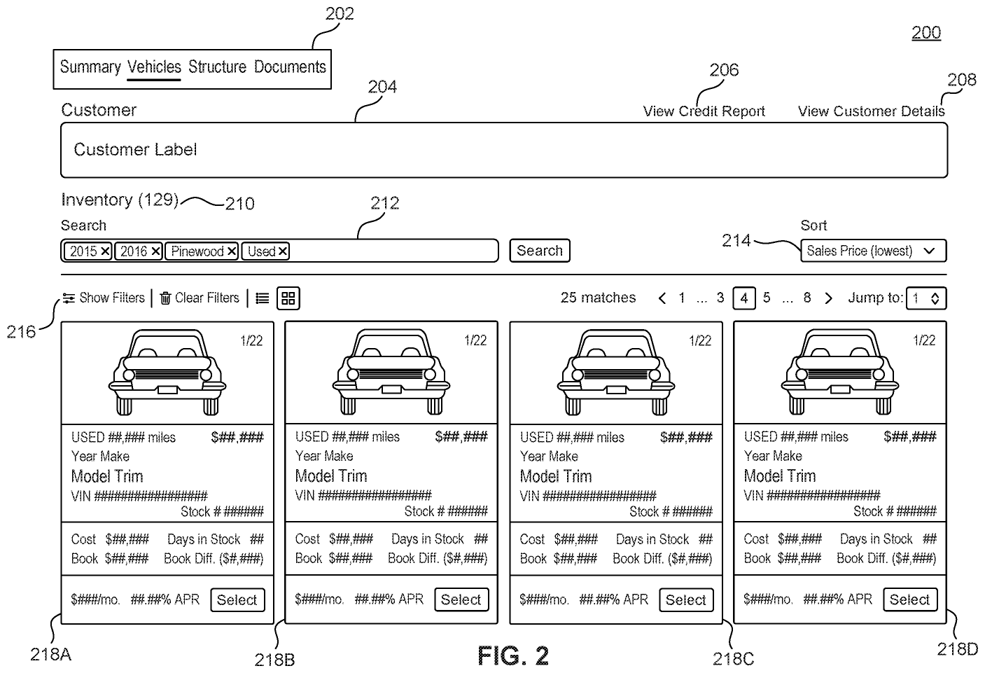

Sales management tool 110 may provide a seller with various business management tools and services. For example, sales management tool 110 may provide customer-relationship management tools, inventory management, personnel management, and any other suitable functions. In the context of a dealership, sales management tool 110 may manage an inventory of vehicles, track sales, handle finances, market vehicles, create invoices, and perform a wide-array of other tasks. Sales management tool 110 may provide a search page, via which user 102 may examine a representation of the items in inventory 108. Such a search page is described in further detail below with reference to FIG. 2. Search management tool 110 may narrow, limit, and/or filter the results displayed in the search results to those items in the inventory that both satisfy consumer-affordability needs and lender-policy requirements. Sales management tool 110 may enhance the search results by applying dealer characteristics to the results. Sales management tool 110 may allow additional filtering, grouping, sorting, etc. of the search results. Sales management tool 110 may include user interface component 111, search interface 112, data store 113, search results generator 114, consumer constraint engine 116, lender policy and pricing engine 118, dealer engine 120, and dealer profile 122.

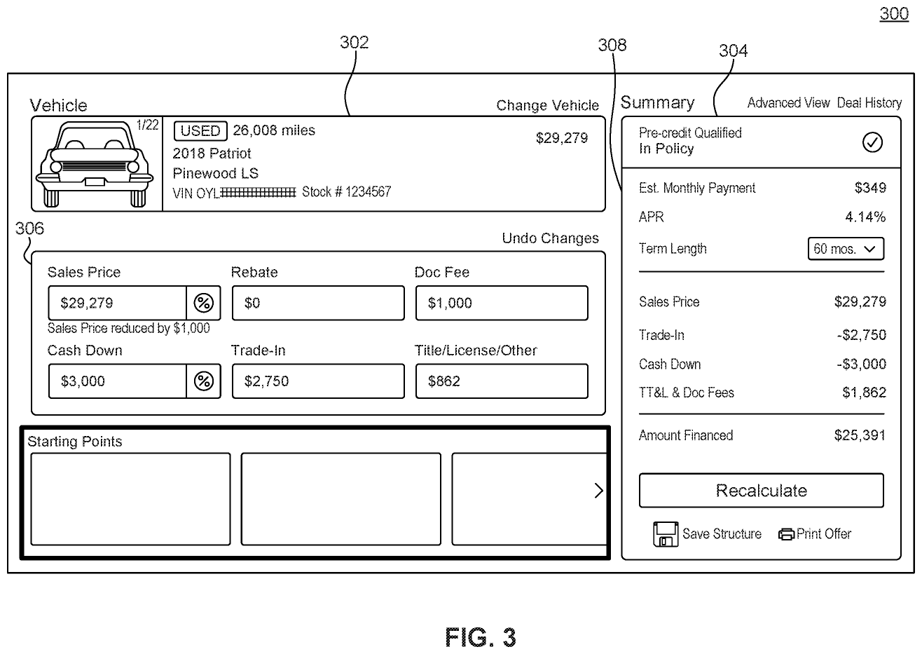

User interface components 111 may be employed by sales management tool 110 to render a user interface that includes a search page for view by user 102 using computing device 104. User interface components 111 may include a JavaScript user interface library to facilitate dynamic interactions between user 102 and sales management tool 110. User interface components 111 may allow a business or organization to upgrade components used by sales management tool 110 to change the experience for user 102 over time. Thus, the look and feel of the particular page may change over time, and the screen displays displayed in FIGS. 2 and 3 are merely exemplary.

Search interface 112 may provide a visual mechanism through which user 102 may examine a representation of items within inventory 108. Search interface 112 may provide to user 102 a search result that includes a list of available items, e.g., a subset of the total inventory of vehicles available at the dealership along with a wide-array of other details about the items and performable operations thereon. In an embodiment, the subset of the total inventory of items may be derived by examining consumer constraints for a possible customer against available permutations of financial structure and item in the inventory. Search interface 112 may provide additional capabilities to user 102 to further limit, refine, sort, group, and otherwise interact with the search results. One exemplary example of a search interface is described below with reference to FIG. 2.

Data store 113 may be a plurality of data storage systems housing information relevant to, used in, and stored by sales management tool 110 and include a representation of inventory 108. Data store 113 may further house pricing information, customer information, sales records, etc. For instance, data store 113 may be a database management system or relational database tool. Data store 113 may further be a message queue or stream processing platform such as Apache Kafka or Apache Spark or other data storage systems like Apache Hadoop, HDFS, or Amazon S3, to name just some examples. Data store 113 may be a data lake, data silo, semi-structured data system (CSV, logs, xml, etc.), unstructured data system, binary data repository, or other suitable repository. Data store 113 may store thousands, millions, billions, or trillions (or more) of objects, rows, transactions, records, files, logs, etc. while allowing for the creation, modification, retrieval, archival, and management of this data. In an embodiment, data store 113 uses scalable, distributed computing to efficiently catalog, sort, manipulate, and access stored data.

Search results generator 114 may be employed by sales management tool 110 to generate search results and return the results to user 102 via search interface 112. To generate appropriate search results, search results generator 114 may employ consumer constraint engine 116, lender policy and pricing engine 118, and dealer engine 120. By employing these components, search results generator 114 may narrow, limit, and/or filter the results displayed in the search results to those representations of items in inventory 108 that both satisfy consumer-affordability needs and lender-policy requirements.

Consumer constraint engine 116 may derive, store, and provide a variety of consumer constraints and financial considerations about a multitude of past, current, and potential customers. Example consumer constraints include desired monthly payment, income, credit score or rating, cash available for a down payment, and a variety of other individualized/personalized financial indicators. In one embodiment, consumer constraint engine 116 may ascertain particularized consumer constraints for potential customer 106 by employing a pre-approval intake process. Such an embodiment may gather financial information from potential customer 106 and facilitate the generation of pre-approval documents from a lender. This acquiring of consumer constraints may also be accomplished through an intake process that automatically ascertains financial information while pre-qualifying the potential customer with a qualified lender. In another embodiment, consumer constraint engine 116 may import information about potential customer 106 from ancillary systems. In another embodiment, user 102 may manually enter consumer constraint information into sales management tool 110.

Lender policy and pricing engine 118 may catalog numerous permutations of financial structures acceptable by one or more qualified lenders and the seller for items in inventory 108. Lender policy and pricing engine 118 may harness or leverage an appropriate constraint programming toolkit or library that provides software for combinatorial optimization to catalog the numerous permutations in a reasonable amount of time. Lender policy and pricing engine 118 may place additional limitations on the financial structures to include in the permutations based on a calculated threshold of likely acceptability, i.e., how likely it is to be acceptable to the lender and the seller. Lender policy and pricing engine 118 may omit from the permutations financial structures falling below a certain threshold of likely acceptability.

Lender policy and pricing engine 118 may also catalog the permutations of financial structures based on information about potential customer 106. In an embodiment, lender policy and pricing engine 118 may calculate the financial structures. In another embodiment, lender policy and pricing engine 118 may access one or more third party lender systems via API call, function, etc. to retrieve a catalog of possible permutation.

For example, in some embodiments every single available financing option for at least one lender across all of the vehicles at a dealership may be cataloged. In this example, the vehicles catalogued may be refined or expanded using pre-filtering, e.g., based on vehicle preferences such as make, model, year, type, etc. Lender policy and pricing engine 118 may determine structures may describe financial arrangements for the financing of the purchase of a vehicle such as: price, rebate value, cash down, taxes, licensing/plating fees, trade-in values, APR or interest rate, term lengths, amount of back-end product (GAP, Warranty), and a variety of other variables. Such structures may be grouped according to equity requirements, e.g., to increase a down payment and/or to decrease a sales price, to allocate financing into a front-end and/or backend, etc.

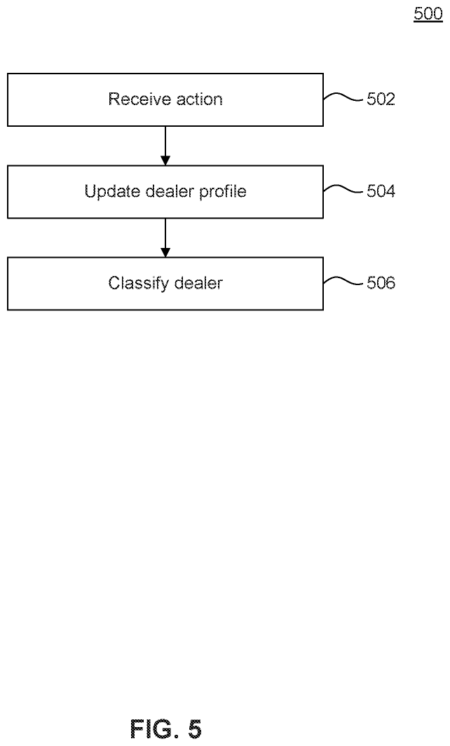

Dealer engine 120 may catalog, track, and maintain a litany of information about a dealer. Dealer engine 120 may compile information about a dealer (or other appropriate seller) as a dealer interacts with sales management tool 110 or ancillary systems. Dealer engine 120 may provide the information to search interface 112 to limit the search results to a subset of the inventory that matches dealer preferences and characteristics. Dealer engine may build a dealer profile, such as dealer profile 122, as described in further detail below with reference to FIG. 5. Dealer engine 120 may provide information about the dealer to lender policy and pricing engine 118 to allow lender policy and pricing engine 118 to vary the possible permutations based on characteristics and preferences of the dealer. For example, a dealership may have demonstrated a willingness to adjust prices downward when completing sale. For such a dealership, the lender policy and pricing engine 118 may consider the list price as a dynamic variable in determining the permutations to consider.

Dealer profile 122 may store information about the behavior of a dealership over time to improve search results by tailoring the search results to the dealerships unique characteristics. For example, dealer profile 122 may include a dealer class associated with a dealership. For example, a dealer class may be “no haggle,” for a dealership that does not negotiate certain contractual terms with potential customer 106. Such a dealer class may be used by dealer engine 120 in tandem with search results generator 114 to provide structures to a dealer that the dealer is more likely to accept, e.g., terms that do not include a negotiated rebate or other charges. For another example, a class may be assigned to a dealership of “profit maximizing,” which would offer structures to a dealership that increase the profits from the sale. In some embodiments, dealer profile 122 may store only one class per dealership, with the dealership placed in a suitable bucket. In other embodiments, however, a dealership may be placed in multiple buckets, i.e., assigned more than one class. Thus, as a dealership interacts with sales management tool 110 over time, a class may be assigned to a dealership based on that dealership's behavior, and search results generator 114 may provide search results more suited to a dealership's unique characteristics. In some embodiments, dealer engine 120 may allow a dealership to manually configure dealer profile 122. In this fashion, a dealership may tailor the financial structures provided by lender policy and pricing engine 118 and the search results provided by search results generator 114 to match changing goals. For example, sales goals might change at a particular time of year for a particular dealership towards a focus on moving inventory. For this period, a dealership may manually configure their dealer profile 122 towards an increased likelihood of acceptance across all the financial structures.

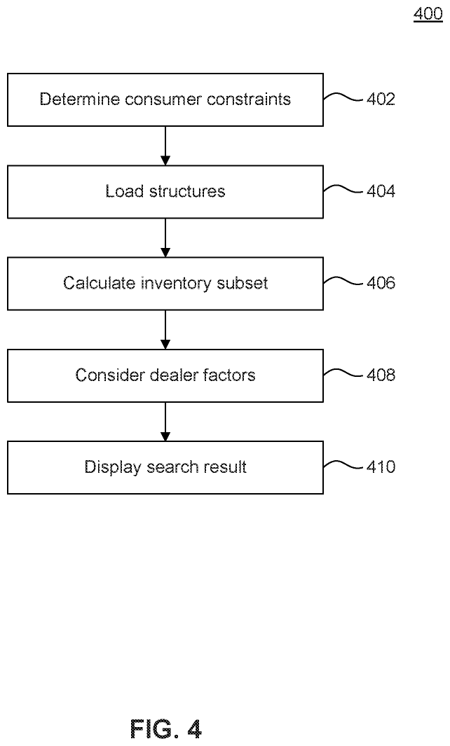

In an embodiment, with the customer-specific financial information provided by consumer constraint engine 116, the set of financial structures from lender policy and pricing engine 118, and the inventory of vehicles from dealer engine 120, search results generator 114 may provide narrowed search results limiting the vehicles displayed in the search result to vehicles that simultaneously meet consumer-affordability, lender-policy requirements, and user-preferences. Given the set of consumer constraints, every single possible permutation of structure for one or more lenders may be considered for every vehicle within the vehicle inventory. These permutations may be grouped according to entity requirements, e.g., all cash down increase, all sales price reduction, or some combination thereof at gradients. The permutations may be further limited by considering user vehicle preferences within lender policy and pricing engine 118. For example, lender policy and pricing engine 118 may refine and pre-filter the permutations of financial structures based on make, model, year, type, etc. as provided by potential customer 106. With only those vehicles and structures displayed that satisfy the consumer constraints, a sales representative is guaranteed to select a vehicle for which financing options are available with at least one lender. This avoids the problem of demoing a vehicle that cannot ultimately be financed to potential customer 106. This process is described in further detail below with reference to FIG. 4.

FIG. 2 is an example screen display of a search result in a sales management tool, according to some embodiments. The screen display provided in FIG. 2 is merely exemplary, and one skilled in the relevant art(s) will appreciate that many approaches may be taken to provide a suitable screen display 200 in accordance with this disclosure. Screen display 200 provides a mechanism through which user 102 may view a subset of represented items in inventory 108, e.g., vehicles, and sort, filter, and otherwise interact with the subset. Screen display 200 may include navigation bar 202, customer 204, view report 206, view details 208, inventory 210, filters 212, sort panel 214, inventory panel 216, and items 218.

Navigation bar 202 may provide user 102 with the ability to navigate to other pages, tabs, subpages, etc. within sales management tool 110. In the exemplary embodiment portrayed in FIG. 2A, navigation bar includes “Summary,” “Vehicles,” “Structure,” and “Documents.” However, these options are merely exemplary and other suitable destinations/links may be provided and these exemplary options removed. “Vehicles” may signify the selected page, i.e., the page in screen display 200 may be accessed by user 102 clicking or selecting the “Vehicles” link. A “Structure” link may provide user 102 with a link to a page to view, alter, modify, delete, update, etc. the available financial structures provided by a lender.

Customer 204 may be a representation, unique identifier, or other signifier of potential customer 106. Customer 204 displays a label of “Customer Label,” however, this may be any suitable user identifier. For instance, customer 204 may include an individual's name, a customer number, a photograph, etc. The information contained in customer 204, i.e., the stored information about potential customer 106, may be manually entered into sales management tool 110, imported from ancillary business systems, or acquired through an automated intake process that pre-qualifies potential customer 106.

View report 206 may provide user 102 with a link to a credit report or other appropriate financial information related to potential customer 106. The credit report may be imported from a credit report provider or generated as part of an automated intake process. The fields displayed when view report 206 is selected may vary across embodiments.

View details 208 may provide user 102 with a link to additional information about potential customer 106. The information on such a customer-details page may include addresses, phone numbers, emails, and other suitable information related to potential customer 106, and may vary across embodiments as well. Additional information may be added by user 102 about potential customer 106 and stored for later usage.

Inventory 210 may represent the determined subset of represented items in inventory 108. This subset may be limited to those items/vehicles that satisfy consumer constraints and lender criteria. This subset may be derived by narrowing the total inventory to only those items in the inventory that have associated financial structures that satisfy or match all the financial constraints of potential customer 106. In an embodiment, inventory 210 may include a count, number, or total that indicates the number of available vehicles that satisfy all of the criteria.

Filters 212 may provide user 102 with the ability to further refine, trim, manipulate, etc. the subset of represented items in inventory 108 that is returned by search results generator 114. In an embodiment, user 102 may enter appropriate filters such as year, make, model, used/new, condition, mileage, etc. In other embodiments, the filters may pertain to the unique characteristics of the particular items in an inventory of items. When user 102 clicks “Search,” the displayed search result may be refined, narrowed, limited, etc. to only those items in the original subset of items that satisfy the user-entered search criteria. In the exemplary embodiment shown in FIG. 2, the search criteria displayed includes “2015”, “2016”, a model limiter of “Pinewood,” and “Used.” In this embodiment, the subset of vehicles may be limited to Used, Pinewood vehicles from 2015 or 2016 when user 102 selects or clicks the search button. User 102 may subsequently update the search criteria by removing criteria, adding criteria, modifying criteria, etc.

Sort panel 214 may allow user 102 to sort and refine the search result in a variety of manners across a multitude of dimensions. For example, in an embodiment, sort panel 214 may allow user 102 to sort by lowest price, highest price, condition, make, model, year, features, engine, MPG, color, fuel-type, etc. In an alternate embodiment, sort panel 214 may include any suitable characteristic or quality of the represented items in inventory 108, depending on the nature of those items. When user 102 modifies the value in sort panel 214, the displayed subset of represented items in inventory 108 may be modified according to the update.

Inventory panel 216 may display the various items, e.g., vehicles, in the determined subset of represented items in inventory 108. Inventory panel 216 may be partitioned to display only a portion of the subset of the inventory when the number of available results makes displaying all of the items on the page at once impractical, unwieldy, or otherwise difficult. In such a situation, inventory panel 216 may employ a suitable HTML or CSS selector to navigate through the inventory of selections. In the example illustration in screen display 200, for instance, a fourth panel is highlighted and user 102 may navigate via the next or previous buttons (“<” and “>”), selecting an appropriate integer (1-8), or by using the “Jump to” selector. Inventory panel 216 may display an appropriate number of vehicles, described below as item 218, based on the screen size or other capabilities of computer device 104. In another embodiment, inventory panel 216 may display other functionalities related to the type of items rendered in the inventory subset.

Items 218, such as item 218B, item 218C, and item 218D, may represent the items, e.g., vehicles, in the determined subset of represented items in inventory 108. In the exemplary embodiment illustrated in screen display 200, a variety of other information is displayed to distinguish items 218, e.g., the VIN, make, year, model number, cost, book value, days in stock, book, differential, payment per month, and APR. In this fashion, user 102 may view only those items that potential customer 106 may ultimately receive financing for from a qualified lender. Items 218 may also allow user 102 to select financing arrangements that best suit the dealership's needs. For instance, in an embodiment, a dealership may be most interested in maximizing profit by minimizing the book differential of the vehicles offered to potential customers. Such a dealership may immediately identify in the search criteria (items 218) those vehicles that best achieve this goal. For another example, a dealership may be most interested in getting rid of vehicles that have been on the lot for the longest amount of time. Such a dealership may immediately identify these vehicles by examining the “days in stock” displayed in the results. In an embodiment, the dealership may sort or curate the results further towards these goals, for example, by sorting the results by “days in stock.” Items 218 may also provide the ability to access further details about the displayed items. In this exemplary screen display, user 102 may select the “Select” button to access additional information about a desired item within the subset of the inventory. Selecting the “Select” button in this fashion may route user 102 to a details page for that item, such as the exemplary screen display described below with reference to FIG. 3. In an embodiment, items 218 may continue to display inventory 108 in its entirety, while providing a visual heuristic on every result in association with each item in items 108. In this embodiment, for example, the visual heuristic may be a red/yellow/green light indicator, a quantitative measure, or other suitable visual heuristic.

FIG. 3 is an example screen display 300 of a search-result details page in a sales management tool, according to some embodiments. The screen display provided in FIG. 3 is merely exemplary, and one skilled in the relevant art(s) will appreciate that many approaches may be taken to provide a suitable screen display 300 in accordance with this disclosure. Screen display 300 may provide user 102 with additional details of a vehicle selected in the inventory subset displayed in exemplary FIG. 2. Screen display 300 may include selected vehicle 302, qualification 304, structure 306, and financing details 308. While screen display 300 displays a dealership-/vehicle-related embodiment, one skilled in the relevant arts will appreciate that a suitable details page could be displayed across embodiments and may vary according to the nature of the items contained in an inventory.

Selected vehicle 302 may represent a vehicle selected from a subset of the inventory, such as item 218A, item 218B, etc. Selected vehicle 302 may provide additional information about the vehicle, e.g., additional photographs of the vehicle, the number of miles, the make and model, engine characteristics, price, and any other suitable characteristics and vehicle-related information. In some embodiments, user 102 may edit the details of the vehicle if they are in possession of sufficient account credentials. In the exemplary embodiment illustrated in screen display 300, selected vehicle 302 displays photographs of the vehicle, an indication of whether the vehicle is new or used, the number of miles on the odometer, the make and model of the vehicle, and the price.

Qualification 304 may provide pre-qualification relating selected vehicle 302 to the potential customer. In the exemplary embodiment of FIG. 3, potential customer 106 is pre-credit qualified and sales management tool 110 indicates this with a checkmark.

Structure 306 may provide the ability to user 102 to further refine the selected structure by changing financial terms. In this exemplary embodiment, user 102 may modify the “sales price,” the “rebate,” the “document fee,” the “cash down,” the “trade-in” and the “title/license/other” fields. However, these examples are merely exemplary and other suitable financial terms may be included and may be modified. One skilled in the relevant arts will appreciate that the specific fields displayed may be different across embodiments.

Financing details 308 may list information about the lender-approved financing and the financial considerations related to selected vehicle 302, potential customer 106, and the relevant lender-approved structures. In the screen display 300, financing details 308 lists the “Est. Monthly Payment,” the “APR,” the “Term Length,” and the “Amount Financed.” The “Est. Monthly Payment” displayed in screen display 300 may be an estimate of the monthly payment. However, in other embodiments, the monthly payment may be a real-time quote that is calculated or received based on the potential customer's financial data, the lender policy, and the vehicle. When user 102 updates the structures in structures 306, user 102 may click the “Recalculate” button to recalculate the financing amount and other numbers displayed in financing details 308. For example, user 102 may wish to view the estimated monthly payment and APR for a 48-month term length and present this information to potential customer 106. By clicking “Recalculate,” user 102 may view a new assessment of (1) which vehicles are within a budget of potential customer 106 and 92) the subset of structures available for each vehicle on the basis of cash down, trade value, consumer monthly budget, etc.

FIG. 4 illustrates a method 400 of providing a search result to a seller of an inventory of items using a sales management tool, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, sales management tool 110 may determine consumer constraints corresponding to potential customer 106. Generally, these consumer constraints may represent financial information about potential customer 106. The consumer constraints may be related to a potential purchase of a represented item in inventory 108, e.g., lender-qualifications for the purchase of an automobile or other vehicle. Specifically, the consumer constraints may include an individual's credit score or credit rating, desired monthly payment, desired down payment, monthly debt obligations, and a litany of other suitable details. In one embodiment, sales management tool 110 may employ consumer constraint engine 116 to ascertain particularized consumer constraints through a pre-approval intake process. The pre-approval intake process may gather financial information from potential customer 106, create necessary pre-qualification documents, and finalize and formalize the pre-approval from the lender. In another embodiment, consumer constraint engine 116 may import information about potential customer 106 from ancillary systems, e.g., other tools used by a lender such as a personal banking application. In yet another embodiment, consumer constraint engine 116 may receive information about potential customer 106 through manual entry. Consumer constraint engine 116 may store the individualized consumer constraints for application/manipulation in subsequent steps. For example, consumer constraint engine 116 may store the consumer constraints as a matrix, single- or multi-dimensional array, or other suitable data structure facilitating later application.

In 404, sales management tool 110 may employ lender policy and pricing engine 118 to load, store, derive, and/or compute all permutations of available financial structures for one or more lenders associated with items in inventory 108. One skilled in the relevant arts will appreciate that the number of permutations of all available financial structures across the entirety of inventory 108 may cover millions, billions, trillions, or more records. Lender policy and pricing engine 118 may process these numerous permutations using a constrained programming approach (e.g., using optimized combinatorial functions provided in a constraint programming toolkit or module) that solves across all possible variants. Such a constrained programming approach optimizes combinatorial solutions by narrowing the search set to find a feasible solution (as opposed to optimal). Lender policy and pricing engine 118 may store the information in a matrix, single- or multi-dimensional array, or other suitable data structure that can process the large number of available structures at a sufficient scale. Lender policy and pricing engine 118 may associate the financial structures with a given dealership. Additional information about the available financial structure may be archived in the form of metadata or other referenced information storage technique.

In 406, sales management tool 110 may employ search results generator 114 to calculate an inventory subset, i.e., a subset, portion, grouping, etc. of the entirety of items in inventory 108. Search results generator 114 may then narrow the multitudinous, exhaustive structures loaded in 404 and the entirety of represented items in inventory 108 by applying the consumer constraints identified in step 402. For example, search results generator 114 may apply a standard limit function using a basic algebraic calculation to remove structure results which exceed the provided monthly payment constraints. In this fashion, search results may be tailored to only include vehicles that satisfy consumer constraints. For example, if potential customer 106 is burdened with a very low credit score, the subset of available vehicles may be limited to those with low prices while requiring large down payment from the user. For another example, if potential customer 106 has a high monthly wage, then the financial structures may be limited to those with a lower APR. By tailoring the search results from the start towards satisfying the consumer constraints, un-financeable options may not be presented at all to user 102 as options to present, demo, or pitch to potential customer 106.

In 408, sales management tool 110 may further narrow the search results, i.e., the subset of represented items in inventory 108 determined in 406, based on a variety of dealer factors. Sales management tool 110 may employ dealer engine 120 to limit the results based on information contained in dealer profile 122. In an embodiment, dealer profile 122 may store dealer-specific preferences in a similar data structure to the consumer constraints and the financial structures. In such an embodiment, the subset of represented items in inventory 108 may be narrowed based on dealer profile 122 using similar methodologies to the initial narrowing of items in inventory 108. However, the application of dealer profile 122 may occur only after search results generator 114 determines the first subset of represented items in inventory 108, which affords sales management tool 110 the ability to present the full-range of inventory-to-financial-structure matches to user 102 for additional sorting, filtering, grouping, and manipulation. In one illustrative example, dealer profile 122 may indicate that a dealership is a “no haggle” dealership, in which case the displayed financing structures may be limited to those that do not include negotiation-based financial considerations such as rebates, trade-ins, title costs, etc. Dealer engine 120 may track behaviors of a particular dealership and build dealer profile 122 over time, and the limitation of the search results may be narrowed in a variety of fashions based on the information stored in dealer profile 122. As described below with reference to FIG. 5, the dealer profile may be updated over time to include additional information about a dealership's behavior and preferences. In this fashion, search results generator 114 may refine the search results further based on a particular dealership's unique behavioral characteristics to further hone search results towards desirable, selectable, and uniquely tailored and targeted results.

In 410, sales management tool 110 may display the search results for user 102. Sales management tool 110 may employ many suitable design approaches to relay the search results. Sales management tool 110 may include visual heuristic confidence indicators confirming that the vehicle meets the lender and consumer constraints. By confirming that the vehicle meets the lender and consumer constraints, user 102 may enjoy the benefits of reduced negotiating cycle time and reduced vehicle switching. One such example is illustrated in exemplary screen display 200. The search results screen may facilitate further refinement of the search results through additional sorting, grouping, and filtering. For example, user 102 may enter a detail applicable to items in inventory 108, and the items will be further limited to display only that detail. In other embodiments, sales management tool 110 may display search results in a table, spreadsheet, graph or other visualization, document, text file, or other suitable medium.

FIG. 5 is a flowchart illustrating a method of updating a dealer profile in a sales management tool, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, sales management tool 110 may receive an action from a seller, e.g., user 102. Sales management tool 110 may receive the action when user 102 views an inventory of items displayed in search results. For example, user 102 may select an additional filter, such as a $0 down payment. For another example, user 102 may sort the search results using sort panel 214 to organize the results by “number of days in inventory,” “highest gross profit,” or another search field. User 102 may also select a particular item, e.g., item 218A, to view more information about the item on the details page, such as displayed in FIG. 3. In another embodiment, sales management tool 110 may receive the action in another context, such as reviewing receipts, sales, user information, personnel information, details about the inventory in other screens/pages, etc. Or sales management tool 110 may receive information about a seller's actions via an ancillary system or an external process.

In 504, sales management tool 110 may employ dealer engine 120 to update dealer profile 122 based on the action received in 502. Sales management tool 110 may record the action using dealer engine 120. Sales management tool 110 may update dealer profile 122 using dealer engine 120. Sales management tool 110 may update information stored in data store 113 with the updates to the dealer information. In some embodiments, information about the dealer's behavior, actions, and preferences may be stored in data store 113. Thus, over time, dealer engine 120 may develop dealer profile 122 to indicate that the dealership is more likely to select the $0 down payment. As described above, dealer profile 122 may be used by search results generator 114 to provide search results that are further limited to the unique characteristics of the specific dealer/seller. For example, if user 102 frequently sorts the subset of represented items in inventory 108 returned in search results by “lowest price,” dealer engine 120 may update dealer profile 122 to automatically trim the search results to those beneath a particular cost threshold.

In 506, sales management tool 110 may employ dealer engine 120 to determine a class for the dealership based on the actions recorded in dealer engine 120. This class may be thought of as a “bucket” that the dealer is placed in based on prior behaviors and the entirety of the data contained in dealer profile 122. For instance, a dealer that frequently maximizes book price may be placed into a “profit maximizing dealership.” A dealership that does not accept or infrequently accepts trade-ins or offer rebates may be placed into a “no-haggle” dealership. By grouping the dealerships/sellers in this fashion, additional behavioral characteristics may be garnered about the dealership based on their association with the category. For example, a “no-haggle” dealership may be prone to offer specific types of financial structures that facilitate easy closing for a customer. These buckets may be useful in other settings, i.e., outside of a search context, within sales management tool 110. For example, “profit maximizing dealerships” may share behaviors that extend into invoice management, billing, customer relations, and other components of sales management tool 110.

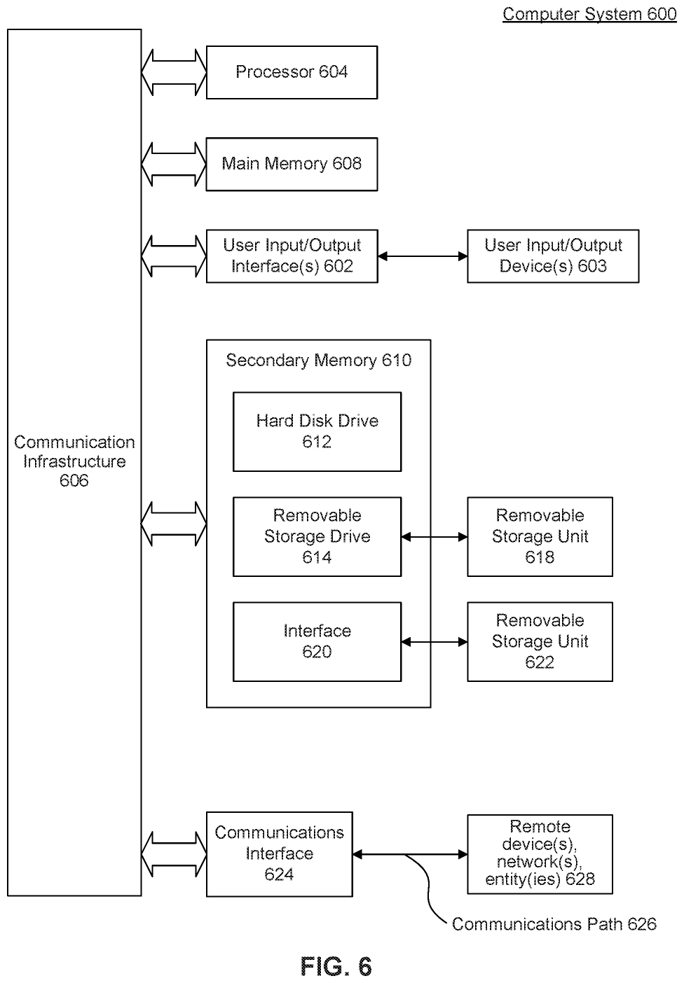

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 608, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618.

Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. A computer implemented method, comprising:
storing, in association with a lender system, information about an inventory of items associated with a seller, the information being accessible to the seller via a remote sales management tool;
receiving, by one or more processors, an inquiry from the seller via the remote sales management tool, the inquiry including information identifying a potential customer;
calculating and associating, by the one or more processors, corresponding financial structures of a plurality of financial structures to each item of a plurality of items in the inventory of items, wherein the financial structures provide a plurality of lender approved financing options for the potential customer for each respective item of the plurality of items;
determining, by the one or more processors, consumer constraints that provide financial details about the potential customer;
determining, by the one or more processors, seller preferences and behavioral characteristics based on a stored seller profile that is built by associating the seller with a class based on an action performed on a past search result by the seller in the remote sales management tool, wherein the class is selected from a set of classes comprising a no-haggle class that limits the financial structures to those that do not include negotiation-based financial considerations;
employing, by the one or more processors, constraint programming to limit the plurality of items to a first inventory subset by comparing lender qualifications in each of the plurality of lender approved financing options to the consumer constraints and then, upon generating the first inventory subset, comparing the lender approved financing options to the seller preferences and behavioral characteristics to further narrow the first inventory subset to a second inventory subset of items in the inventory of items having a financial structure that simultaneously matches the consumer constraints, the seller preferences, and the behavioral characteristics, wherein the consumer constraints, the plurality of lender approved financing options, the seller preferences, and the behavioral characteristics are stored respectively in similar arrays; and
providing, by the one or more processors, a search result, in response to the inquiry, for displaying in the remote sales management tool,
wherein the search result displays the second inventory subset, financing details comprising an APR and a payment per month from a financial structure in the financial structures for each displayed item in the second inventory subset, and a sort panel to sort and refine the search result, and wherein the search result further displays the first inventory subset in response to an input.

2. The method of claim 1, wherein the remote sales management tool is a vehicle sales management tool and the inventory of items is an inventory of vehicles at the seller, wherein the seller is a dealership.

3. The method of claim 1, further comprising:
receiving search criteria, wherein the search criteria comprises a characteristic;
determining a third inventory subset by limiting the inventory subset to items having the characteristic; and
re-displaying the search result to include the third inventory subset.

4. The method of claim 1, further comprising:
receiving search criteria, wherein the search criteria comprises an updated structure parameter; and
narrowing the financial structure subset to a second financial structure subset by applying the updated structure parameter to the financial structures and matching the financial structures to the consumer constraints.

5. The method of claim 1, wherein the consumer constraints comprise a credit score and a monthly payment amount.

6. The method of claim 1, the receiving the consumer constraints comprising:
providing an intake pre-qualification process to the potential customer; and
determining the consumer constraints based on results of the intake pre-qualification process.

7. The method of claim 1, further comprising:
receiving information about a new item;
adding the new item to the inventory of items; and
associating additional financial structures with the new item.

8. A system, comprising:
a memory; and
at least one processor coupled to the memory and configured to:
store, in association with a lender system, information about an inventory of items associated with a seller, the information being accessible to the seller via a sales management tool;
receive an inquiry from the seller via the sales management tool, the inquiry including information identifying a potential customer;
calculate and associate corresponding financial structures of a plurality of financial structures to each item of a plurality of items in the inventory of items, wherein the financial structures provide a plurality of lender approved financing options for the potential customer for each respective item of the plurality of items;
determine consumer constraints that provide financial details about the potential customer;
determine seller preferences and behavioral characteristics based on a stored seller profile that is built by associating the seller with a class based on an action performed against a past search result by the seller in the sales management tool, wherein the class is selected from a set of classes comprising a no-haggle class that limits the financial structures to those that do not include negotiation-based financial considerations;
employ constraint programming to limit the plurality of items to a first inventory subset by comparing lender-qualifications in each of the plurality of lender approved financing options to the consumer constraints and then, upon generating the first inventory subset, comparing the lender-approved financing options to the seller preferences and behavioral characteristics to further narrow the first inventory subset to a second inventory subset of items in the inventory of items having a corresponding financial structure that simultaneously matches the consumer constraints, the seller preferences, and the behavioral characteristics, wherein the consumer constraints, the plurality of lender approved financing options, the seller preferences, and the behavioral characteristics are stored respectively in similar arrays; and
provide a search result, in response to the inquiry, for displaying in the sales management tool, wherein the search result displays the second inventory subset, financing details comprising an APR and a payment per month from a financial structure in the financial structures for each displayed item in the second inventory subset, and a sort panel to sort and refine the search result, and wherein the search result further displays the first inventory subset in response to an input.

9. The system of claim 8, wherein the sales management tool is a vehicle sales management tool and the inventory of items is an inventory of vehicles at the seller, wherein the seller is a dealership.

10. (canceled)

11. (canceled)

12. (canceled)

13. The system of claim 8, the at least one processor further configured to:
group the inventory subset and the financial structure subset into schematic groups, wherein the schematic groups arrange the inventory of items according to types of the financial structures.

14. The system of claim 8, wherein the financial structures are received from a qualified lender.

15. A non-transitory computer-readable device having instructions stored thereon that, when executed by at least one computing device, cause the at least one computing device to perform operations comprising:
storing, in association with a lender system, information about an inventory of items associated with a seller, the information being accessible to the seller via a sales management tool;
receiving an inquiry from the seller via the sales management tool, the inquiry including information identifying a potential customer;
calculating and associating corresponding financial structures of a plurality of financial structures to each item of a plurality of items in the inventory of items, wherein the financial structures provide a plurality of lender approved financing options for the potential customer for each respective item of the plurality of items;
determining consumer constraints that provide financial details about the potential customer;
determining seller preferences and behavioral characteristics based on a stored seller profile that is built by associating the seller with a class based on an action performed against a past search result by the seller in the sales management tool, wherein the class is selected from a set of classes comprising a no-haggle class that limits the financial structures to those that do not include negotiation-based financial considerations;
employing constraint programming to limit the plurality of items to a first inventory subset by comparing lender qualifications in each of the plurality of lender approved financing options to the consumer constraints and then, upon generating the first inventory subset, comparing the lender approved financing options to the seller preferences and behavioral characteristics to further narrow the first inventory subset to a second inventory subset of items in the inventory of items having a corresponding financial structure that simultaneously matches the consumer constraints, the seller preferences, and the behavioral characteristics, wherein the consumer constraints, the plurality of lender approved financing options, the seller preferences, and the behavioral characteristics are stored respectively in similar arrays; and
providing a search result, in response to the inquiry, for displaying in the sales management tool,
wherein the search result displays the second inventory subset, financing details comprising an APR and a payment per month from a financial structure in the financial structures for each displayed item in the inventory subset, and a sort panel to sort and refine the search result, and wherein the search result further displays the first inventory subset in response to an input.

16. The non-transitory computer-readable device of claim 15, wherein the sales management tool is a vehicle sales management tool and the inventory of items is an inventory of vehicles at the seller, wherein the seller is a dealership.

17. The non-transitory computer-readable device of claim 15, the operations further comprising:
sorting the inventory subset displayed in the search result based on number of days in stock for each item in the inventory of items.

18. The non-transitory computer-readable device of claim 15, the operations further comprising:
sorting the inventory subset displayed in the search result based on differences between retail prices and negative book values within the inventory of items.

19. The non-transitory computer-readable device of claim 15, the operations further comprising:
sorting the inventory subset displayed in the search result based on prices within the inventory of items.

20. The non-transitory computer-readable device of claim 16, the operations further comprising:
sorting the inventory subset displayed in the search result based on models of the items within the inventory of items.

21. The method of claim 1, wherein the action is a sorting of grouping of the past search result.

22. The system of claim 8, wherein the action is a sorting of grouping of the past search result.

22. The non-transitory computer-readable device of claim 15, wherein the action is a sorting of grouping of the past search result.
